(19) United States
(12) Patent Application Publication
(10) Pub. No.: US 2013/0029003 A1
(43) Pub. Date: Jan. 31, 2013

(54) COMPRESSION MOLDING MACHINE

(71) Applicants: Jun OYAMA, Kyoto (JP); Tomohiro Kakitani, Kyoto (JP)

(72) Inventors: Jun OYAMA, Kyoto (JP); Tomohiro Kakitani, Kyoto (JP)

(73) Assignee: KIKUSUI SEISAKUSHO LTD., Kyoto-shi (JP)

(21) Appl. No.: 13/517,720

(22) Filed: Jun. 14, 2012

(30) Foreign Application Priority Data
Jul. 26, 2011 (JP) P2011-163059

(51) Int. Cl. B29C 43/32

(52) U.S. Cl. 425/457

(57) ABSTRACT

A compression molding machine includes a plurality of plate units that are provided between a lower punch retainer and an upper punch retainer. The plate units each include: a plate having a through bore to be filled with a powdery material that is compressed by an upper punch and a lower punch; and a plate attachment member having a mount portion mounted to a vicinity of an upright shaft, a positioning surface positioning the upper surface of the plate, and a plate attaching portion attaching the plate from below to above, such that the upper surface of the plate is positioned at the positioning surface.

### BACKGROUND

As disclosed in Japanese Patent Publication No. 3847412 and the like, there has been conventionally known a rotary compression molding machine that includes: a frame; an upright shaft provided in the frame; a lower punch retainer that is attached to the upright shaft and retains lower punches so as to allow upward and downward reciprocation; an upper punch retainer that is attached to the upright shaft and retains upper punches so as to allow upward and downward reciprocation; and a plurality of plates that are provided between the lower punch retainer and the upper punch retainer and each have at least one through bore to be filled with a powdery material compressed by the upper punch and the lower punch. Each of the plurality of plates disclosed in Japanese Patent Publication No. 3847412 is positioned in the direction of rotation by a positioning pin, and is fixed by a setting bolt that is laterally inserted. This configuration complicates the shapes of the plates and the arrangement for positioning the plates. Further, due to slight difference in thickness, such as at most several percents, which is caused in the production of the plates, the upper surfaces of the positioned plates may not be at the same height. In this case, there arise the following problems. Specifically, the powdery material may be accumulated in an uneven joint portion between the upper surfaces of the adjacent plates. Moreover, the powdery material may leak through a gap between the upper surfaces of the plates and a filling apparatus that fills the powdery material in the through bores of the plates.

Meanwhile, as disclosed in Japanese Unexamined Patent Publication No. 2009-000692 and the like, there has been proposed a configuration for preventing complication in arrangement, of attaching and detaching an integrally formed turret (plate) to be sandwiched from upward and downward between an upper punch retainer and a lower punch retainer, which are provided separately from each other at upper and lower positions. However, even in this configuration disclosed in Japanese Unexamined Patent Publication No. 2009-000692, the upper punch retainer needs to be lifted upward upon replacing only the turret, which takes time and requires troublesome work.

### SUMMARY OF INVENTIONS

The present invention has been achieved in view of the above problems, and an object thereof is to provide a compression molding machine that facilitates attachment and detachment of a plurality of plates, as well as realizes relative positioning of upper surfaces of the respective plates with a high degree of accuracy.

According to the present invention, a compression molding machine includes: a frame; an upright shaft provided in the frame; a lower punch retainer attached to the upright shaft and retaining at least one lower punch so as to allow upward and downward reciprocation; an upper punch retainer attached to the upright shaft and retaining at least one upper punch so as to allow upward and downward reciprocation; and a plurality of plate units provided between the lower punch retainer and the upper punch retainer; wherein the plate units each include: a plate having at least one through bore filled with a powdery material that is compressed by the upper punch and the lower punch; and a plate attachment member having a mount portion mounted to a vicinity of the upright shaft, a positioning surface positioning an upper surface of the plate, and a plate attaching portion attaching the plate from below to above, such that the upper surface of the plate is positioned at the positioning surface.

In this configuration, even in the case where there are provided a plurality of plate units, the upper surfaces of the plates are brought into intimate contact with the positioning surfaces and thus positioned, respectively. Accordingly, the upper surfaces of the plates can be relatively positioned with a high degree of accuracy even with such simple arrangement. For example, even when slight difference in thickness is caused during the production of the plates, such as at most several percents, the plates are each attached to the positioning surface of corresponding one of the plate attachment members, with a result that the upper surfaces of the plates can be relatively positioned with a high degree of accuracy. Therefore, difference in height is less likely to be caused between the upper surfaces of the plates.

In order to facilitate repair and maintenance work of the machine, the plate units are desirably configured to be attachable and detachable.

In order to relatively position the upper surfaces of the plates with a higher degree of accuracy, the mount portion desirably has a downward surface in intimate contact with an upward surface provided to a vicinity of the upright shaft, and a fixing portion fixing, from above, the downward surface to the upward surface. In this configuration, the plate units are fixed securely.

In one specific aspect of the above configuration, the upward surface may be formed integrally to the upright shaft.

Further, in a desired configuration that realizes relative positioning of the upper surfaces of the plates of the plate units with a higher degree of accuracy, the upright shaft includes: a shaft main body to which the lower punch retainer and the upper punch retainer are attached; and a unit attaching portion fixed to the shaft main body, the plate units being attached to the unit attaching portion; and the upward surface is formed on the unit attaching portion.

Because the unit attaching portion is provided separately from the upright shaft, the upward surface can be easily processed, which leads to accuracy in horizontal alignment. The upward surface having such accuracy in horizontal alignment easily assures accuracy in relative positioning of the upper surfaces of the plates.

In another aspect of the configuration that realizes relative positioning, with a higher degree of accuracy, of the upper surfaces of the plates included respectively in the plate units, the mount portion may have a downward surface in intimate contact with an upward surface provided to a cylindrical member that is externally fitted to the upright shaft, and a fixing portion fixing, from above, the downward surface to the upward surface.

In this configuration, the cylindrical member can be formed separately from the upright shaft. Therefore, the portion of the cylindrical member to be made in intimate contact with the downward surface of the plate attachment member, namely, the upward surface, realizes accuracy in horizontal alignment.

In still another aspect of the configuration that realizes relative positioning, with a higher degree of accuracy, of the upper surfaces of the plates included respectively in the plate units, the mount portion may have a downward surface in intimate contact with an upward surface provided to the lower punch retainer, and a fixing portion fixing, from above, the downward surface to the upward surface.

Further, in order to facilitate attachment and detachment of the plate units as well as to effectively prevent damages to the plate units, the upward surface of the lower punch retainer, and the like, due to hitting, friction, or the like with any other member, the plate units desirably have a protective member that covers an inner edge of a lower surface of each of the plates.

In still another configuration that realizes relative positioning of the upper surfaces of the plates with a higher degree of accuracy, a press member is preferably included to partially or entirely press downward the upper surfaces of the plate attachment members of the respective plate units. In particular, the single press member is preferably provided to expand over the respective plate units. The press member may be formed into a ring shape, a fan shape, or the like.

The powdery material in the invention refers to an aggregate of minute solids and includes an aggregate of particles such as what they call granules and an aggregate of powder smaller than the particles.

### BRIEF DESCRIPTION OF THE DRAWINGS

FIG. 1 is a front sectional view of a compression molding machine according to an embodiment of the present invention;

FIG. 2 is a front sectional view of a main portion of the compression molding machine according to the embodiment;

FIG. 3 is a plan view of a main portion of the compression molding machine according to the embodiment;

FIG. 4 is a view for explaining the operations of the compression molding machine according to the embodiment;

FIG. 5 is another view for explaining the operations of the compression molding machine according to the embodiment;

FIG. 6 is a front sectional view of a main portion of a compression molding machine according to a second embodiment of the present invention;

FIG. 7 is a front sectional view of a main portion of a compression molding machine according to a third embodiment of the present invention;

FIG. 8 is a front sectional view of a main portion of a compression molding machine according to a fourth embodiment of the present invention; and

FIG. 9 is a front sectional view of a main portion of a compression molding machine according to a fifth embodiment of the present invention.

### DESCRIPTION OF THE PREFERRED EMBODIMENTS

### First Embodiment

Described below is a compression molding machine according to a first embodiment of the present invention with reference to the drawings.

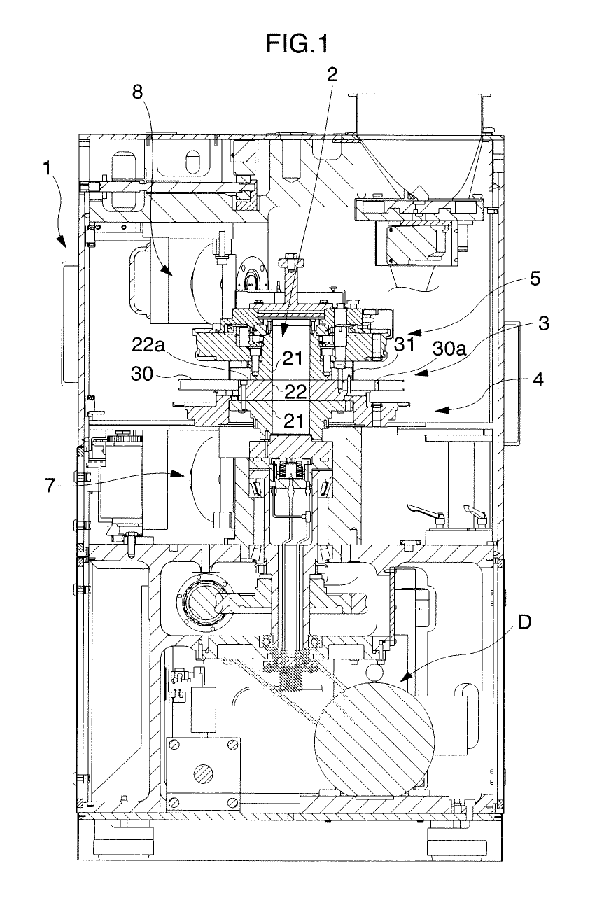

As shown in FIG. 1, a rotary compression molding machine (hereinafter, referred to as the molding machine) according to this embodiment includes a frame 1, an upright shaft 2 that is rotatably provided in the frame 1, three plates 30 that are aligned to locate surfaces thereof so as to be substantially flat and to configure a circular shape in a plan view, a lower punch retainer 4, and an upper punch retainer 5, wherein the three plates 30 are located between the lower punch retainer 4 and the upper punch retainer 5 so as to be horizontally rotatable about the upright shaft 2. The molding machine has a configuration basically same as that of a molding machine including the plates 30 and known in the art, and operates in a similar manner to compress, with upper punches and lower punches, a powdery material for a pharmaceutical tablet or a food product so as to mold the powdery material into a molded product. Therefore, minimum reference will be made to the basic configuration exclusive of the features of the present invention. It is noted that, in the present embodiment, the upper punches and the lower punches will not be illustrated in the drawings for the purpose of easier description.

The molding machine according to the present embodiment includes a plurality of plate units 3 between the lower punch retainer 4 and the upper punch retainer 5. Each of the plate units 3 includes one of the plates 30, mount portions 31a, a positioning surface 31b, and a plate attachment member 31. Each of the plate 30 has through bores 30a to be filled with a powdery material that is compressed by the upper punches and the lower punches. The mount portions 31a attach the plate 30 to a vicinity of the upright shaft 2. The positioning surface 31b positions an upper surface 30b of the plate 30. The plate attachment member 31 has plate attaching portions 31c for attaching the upper surface 30b of the plate 30 to the positioning surface 31b so as to attach the plate 30 from below to above.

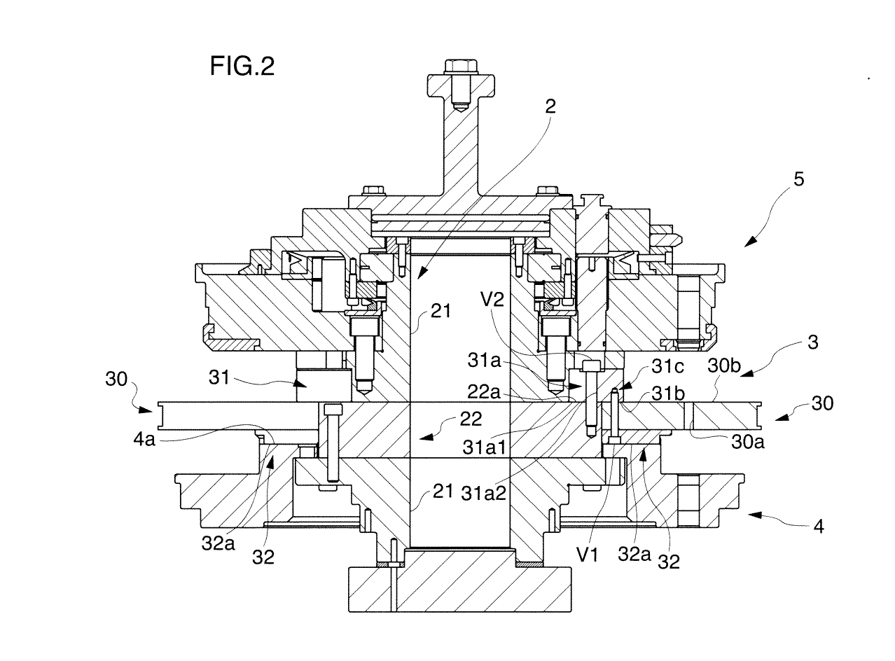

Described below with reference to FIGS. 1 to 6 are the configurations of the respective portions in the molding machine.

The upright shaft 2, which is hollow, is detachably connected with the plate units 3. The upright shaft 2 is driven to be rotated by an electric motor D shown in FIG. 1. The upright shaft 2 has a shaft main body 21 and a unit attaching portion 22. The lower punch retainer 4 and the upper punch retainer 5 are attached to the shaft main body 21. The unit attaching portion 22 is fixed to the shaft main body 21 from above and below, and the plate units 3 mentioned above are attached to the unit attaching portion 22. The unit attaching portion 22 has an upward surface 22a that is in direct contact with the plate units 3.

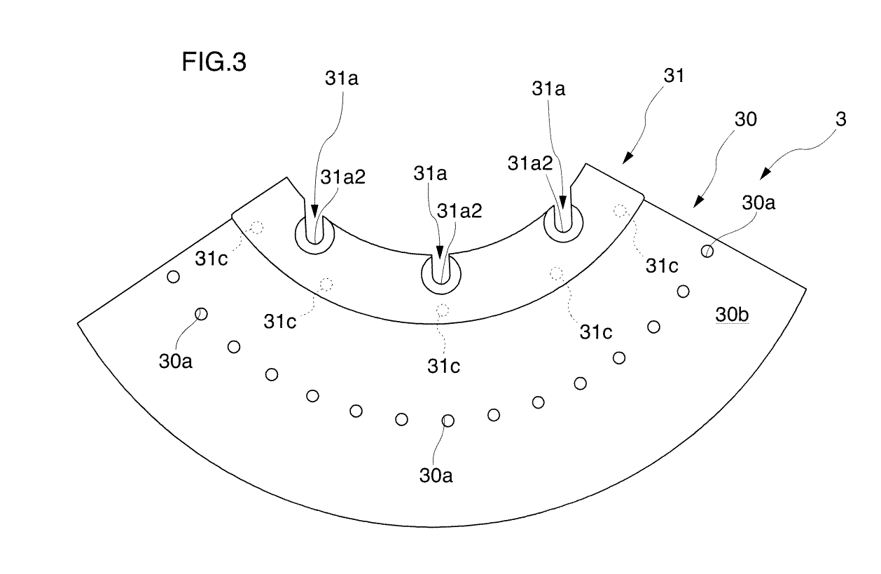

As shown in FIG. 3, each of the plate units 3 has a substantially fan shape of 120 degrees in a plan view. The molding machine according to the present embodiment has the three plate units 3 configured identically. The plate units 3 are configured to be attachable to and detachable from the vicinity of the upright shaft 2 with no need for detaching the upper punch retainer 5 or the lower punch retainer 4 from the upright shaft 2. Each of the plate units 3 is provided with, in addition to the plate 30 and the plate attachment member 31 mentioned above, a protective member 32 that is attached to the lower surface of the plate 30.

The plate 30 is made smooth at least on the upper surface 30b, and is provided, in an area close to the outer peripheral edge, with the plurality of through bores 30a so as to be aligned circumferentially and spaced apart from each other by a predetermined distance. These through bores 30a are filled with the powdery material for the molded products. When tips of the upper and lower punches are inserted respectively into the through bores 30a and the through bores 30a pass between an upper roll 8 and a lower roll 7 shown in FIG. 1, the powdery material filled in the through bores 30a is compressed and molded into the molded products.

The plate attachment member 31 has the mount portions 31a, the positioning surface 31b, and the plate attaching portions 31c. The mount portions 31a attach the plate 30 to the vicinity of the upright shaft 2. The positioning surface 31b positions the plate 30. The plate attaching portions 31c fix the plate 30 from below to the positioning surface 31b. The mount portions 31a are formed by cutting away three portions on the inner edge of the plate attachment member 31 in a same direction. Accordingly, when bolts V2 are inserted respectively into the mount portions 31a in a predetermined direction, respectively, the bolts V2 can be positioned in the mount portions 31a. In this configuration, in the state where the bolts V2 are temporarily fixed to the vicinity of the upright shaft 2, the plate unit 3 can be mounted laterally. The mount portions 31a each have a downward surface 31a1 and a fixing portion 31a2. The downward surface 31a1 is in intimate contact with the upward surface 22a that is located close to the upright shaft 2. The fixing portion 31a2 fixes the downward surface 31a1 from above to the upward surface 22a. The positioning surfaces 31b are directed downward and are provided so as to relatively position the upper surfaces 30b of the plates 30 with a high degree of accuracy. The plate attaching portions 31c are provided as bores through which bolts V1 are respectively inserted from below, so as to attach the plate 30 from below to the positioning surface 31b. The downward surfaces 31a1 of the mount portions 31a are flush with the positioning surface 31b in the present embodiment. Accordingly, the plate attachment member 31 according to the present embodiment has a partial ring shape with a rectangular shape in a sectional view. The fixing portions 31a2 respectively receive the bolts V2 in the present embodiment. The bolts V1 tighten and fix the protective member 32 as well as the plate attaching portions 31c.

The protective member 32 is tightened together with the plate attachment member 31 by the bolts V1 to the plate 30, thereby to cover the inner edge of the lower surface from below. The protective member 32 has a slide surface 32a, which is made smooth so as to allow the plate units 3 to slide with respect to the lower punch retainer 4 and the like upon attaching and detaching the plate units 3. Because the plate units 3 are slid upon being attached to and detached from the unit attaching portion 22, the plate units 3 can be attached and detached safely with no damages to the plate units 3 or the other peripheral portions.

The protective member 32 is preferably made of a material that is resistant to abrasion, resistant to friction, light, and processable. The protective member 32 may be made of resin, for example. Examples of such resin include polyethylene, polypropylene, polycarbonate, polyether ether ketone, and fluororesin. Alternatively, the protective member 32 may not be made of resin.

In the present embodiment, the plate attachment members 31 are respectively attached to the unit attaching portion 22 by the bolts V2. Alternatively, the attachment method may not be tightening with use of the bolts V2. For example, the plate attachment members 31 may be pressed against the upward surface 22a of the unit attaching portion 22. The attachment method is not limited either in other embodiments.

The lower punch retainer 4 is located below the plates 30 and is fixed to the shaft main body 21. Further, the lower punch retainer 4 retains the lower punches so as to allow upward and downward reciprocation. The lower punch retainer 4 according to the present embodiment has a configuration generally similar to that of a conventional lower punch retainer.

The upper punch retainer 5 is located above the plates 30 and is fixed to the shaft main body 21. Further, the upper punch retainer 5 retains the upper punches so as to allow upward and downward reciprocation. The upper punch retainer 5 according to the present embodiment has a configuration generally similar to that of a conventional upper punch retainer. The upper punch retainer 5 according to the present embodiment is additionally provided with an insertion bore 51 through which a tool G is temporarily inserted from above toward the mount portions 31a and the bolts V2 upon attaching and detaching the plate units 3.

As described above, the molding machine according to the present embodiment is thus configured to attach and detach only the plate units 3 with no need for detaching the upper punch retainer 5 and the lower punch retainer 4 from the upright shaft 2, thereby to facilitate repair and maintenance work.

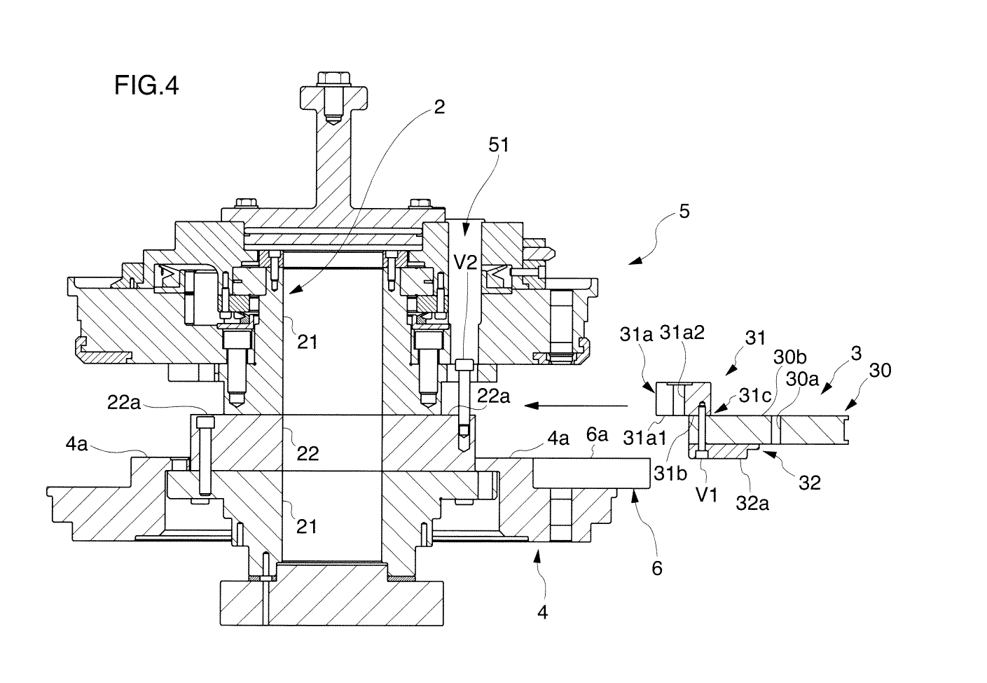

Described below are a series of processes of attaching the plate units 3 with reference to FIGS. 4 to 6. In these processes, an assistive tool 6 is used to realize smooth attachment and detachment of the plate units 3. The assistive tool 6 may be made of resin or the like, which is appropriately molded in accordance with the shape of the lower punch retainer 4, and is configured such that the plate units 3 are less likely to be damaged even if the assistive tool 6 is brought into contact with the plate units 3.

FIG. 4 shows the process before the plate units 3 are attached. The upper punch retainer 5 is preliminarily provided with the insertion bore 51. The assistive tool 6 is attached to the lower punch retainer 4 so as to realize smooth attachment of the plate units 3. The assistive tool 6 has an upper surface serving as a temporal support surface 6a, which is substantially flush with an upward surface 4a of the lower punch retainer 4. The protective member 32 and the plate 30 are preliminarily tightened from below to the positioning surface 31b of the plate attachment member 31 of each of the plate units 3 by means of the bolts V1 respectively at the positions of the plate attaching portions 31c. Each of the plate attachment members 31 and corresponding one of the plates 30 are positioned relatively to each other with a high degree of accuracy.

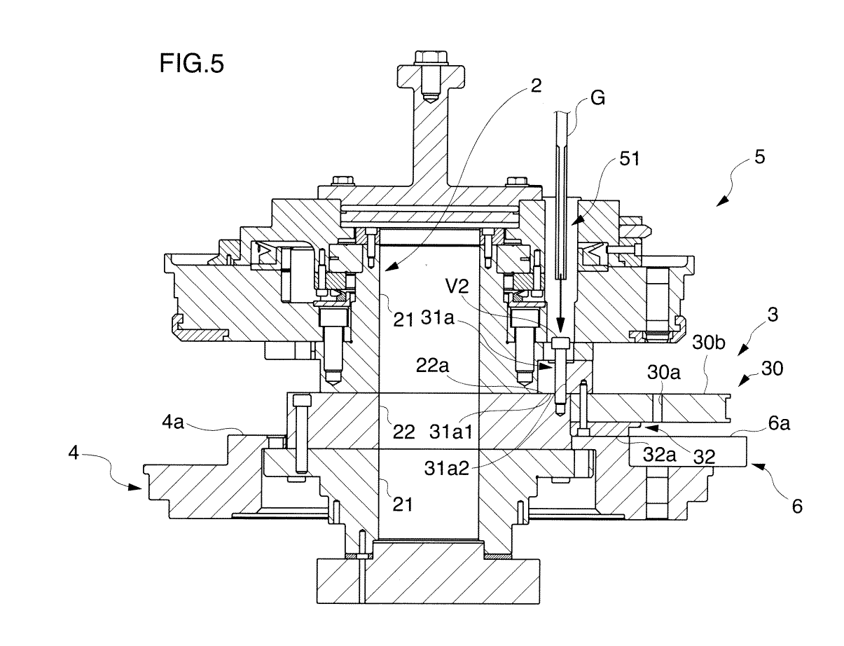

FIG. 5 shows a state where the plates 30 are shifted to predetermined positions. The plate units 3 are positioned as shown in this figure such that the slide surface 32a of the protective member 32 smoothly shifts on the temporal support surface 6a of the assistive tool 6 and the upward surface 4a of the lower punch retainer 4. In this case, the tool G is operated from above to tighten the plate attachment members 31 to the unit attaching portion 22 by means of the bolts V2.

Before the plate units 3 are tightened to the unit attaching portion 22 by means of the bolts V2, the tips of the upper and lower punches and corresponding one of the through bores 30a are aligned axially. This axial alignment is performed, with use of an axial alignment jig, toward each of the through bores 30a from both of corresponding one of lower punch retaining bores provided in the lower punch retainer 4 and corresponding one of upper punch retaining bores provided in the upper punch retainer 5.

The powdery material filled in the through bores 30a is compressed and molded by the tips of the lower punches and the tips of the upper punches. Accordingly, the plate units 3 need to be attached such that the tips of the lower punches and the tips of the upper punches are accurately positioned with respect to the corresponding through bores 30a, respectively. Otherwise, the punches or the plate units 3 may be broken.

The plates 30 may be each attached to corresponding one of the plate attachment members 31 by any attachment method, not being limited to screwing with use of the bolts V1. The attachment may be alternatively made by fitting, welding, or the like, with no use of some component.

When the plate attachment members 31 are tightened respectively by the bolts V2 with use of the tool G, the downward surface 31a1 of each of the plate attachment members 31 is brought into intimate contact with the upward surface 22a of the unit attaching portion 22, and is thus securely fixed thereto. Therefore, the three plates 30 in total each configuring corresponding one of the plate units 3 are securely fixed to the vicinity of the upright shaft 2 with the plate attachment members 31 being interposed therebetween, respectively.

In the molding machine according to the present embodiment thus configured, even in the case where the plurality of plate units 3 are provided, each of the plate units 3 is positioned such that the upper surface 30b of the corresponding plate 30 is in intimate contact with the positioning surface 31b. Therefore, the upper surfaces 30b of the plates 30 can be relatively positioned with a high degree of accuracy even with such simple arrangement.

Further, in the present embodiment, the plate units 3 are configured to be attachable to and detachable from the vicinity of the upright shaft 2, thereby facilitating repair and maintenance work of the molding machine.

In order to achieve relative positioning of the upper surfaces 30b of the plates 30 with a higher degree of accuracy, the mount portions 31a in the present embodiment each have the downward surface 31a1 and the fixing portion 31a2. The downward surfaces 31a1 are brought into intimate contact with the upward surface 22a that is located close to the upright shaft 2. The fixing portions 31a2 each fix, from above, corresponding one of the downward surfaces 31a1 to the upward surface 22a.

Particularly in the present embodiment, the upright shaft 2 has the shaft main body 21 and the unit attaching portion 22, in order to realize positioning of the plates 30 with a higher degree of accuracy. The lower punch retainer 4 and the upper punch retainer 5 are attached to the shaft main body 21. The unit attaching portion 22 is fixed to the shaft main body 21, and the plate units 3 are attached to the unit attaching portion 22. The unit attaching portion 22 has the upward surface 22a. Provision of the unit attaching portion 22 improves accuracy in horizontal alignment of the upward surface 22a. Because the unit attaching portion 22 is provided separately from the shaft main body 21, the upward surface 22a can be easily processed to achieve accuracy in horizontal alignment. The plate units 3 are attached to the horizontally aligned upward surface 22a, so that the upper surfaces 30b of the plates 30 can be relatively positioned with a higher degree of accuracy.

Furthermore, in the present embodiment, the plate units 3 are provided with the protective member 32 that covers the inner edges of the lower surfaces of the plates 30, in order to facilitate attachment of the plate units 3 as well as to effectively prevent damages to the plate units 3 due to hitting or the like with any other member.

### Second Embodiment

Sequentially described below are the other embodiments of the present invention. In each of these embodiments, components equivalent to those of the above embodiment are denoted by the same reference signs, and detailed description thereof will not be repetitively provided.

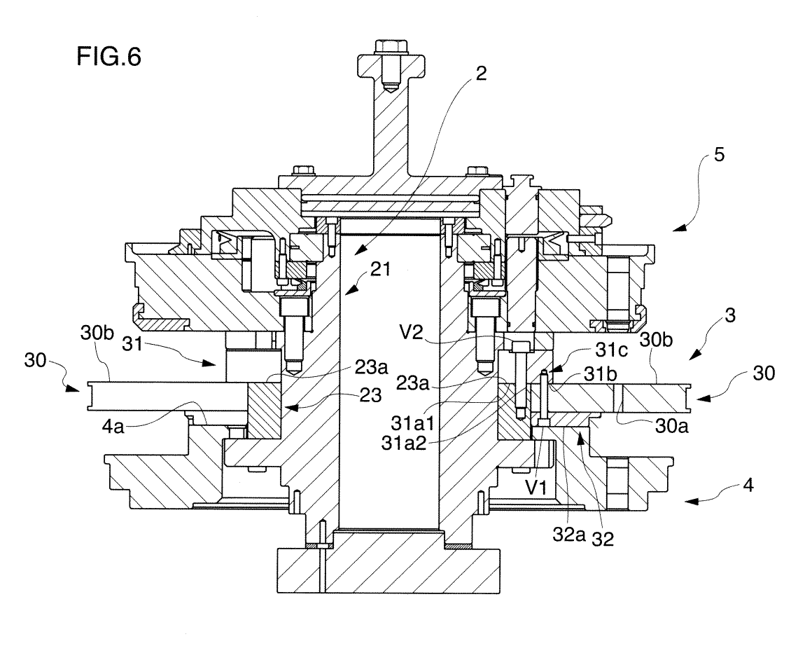

As shown in FIG. 6, a molding machine according to a second embodiment of the present invention is configured such that a cylindrical member 23 is externally fitted to an upright shaft 2. The cylindrical member 23 has an upward surface 23a, to which plate attachment members 31 are attached. The plate attachment members 31 are each provided with mount portions 31a, and each of the mount portions 31a has a downward surface 31a1 and a fixing portion 31a2. The downward surfaces 31a1 are each in intimate contact with the upward surface 23a of the cylindrical member 23, which is externally fitted to the upright shaft 2. The fixing portions 31a2 each fix, from above, corresponding one of the downward surfaces 31a1 to the upward surface 23a.

The cylindrical member 23 is made of steel and is formed into a cylindrical shape, by quenching in order to enhance hardness thereof, for example. The steel cylindrical member has upper and lower ends that are precisely polished so as to be made flat. Accordingly, plate units 3 are securely fixed at the positions of the downward surfaces 31a1, respectively, which are in intimate contact with the upward surface 23a of the cylindrical member 23. In summary, even the above configuration achieves relative positioning of plates 30 of the plate units 3 with a higher degree of accuracy.

### Third Embodiment

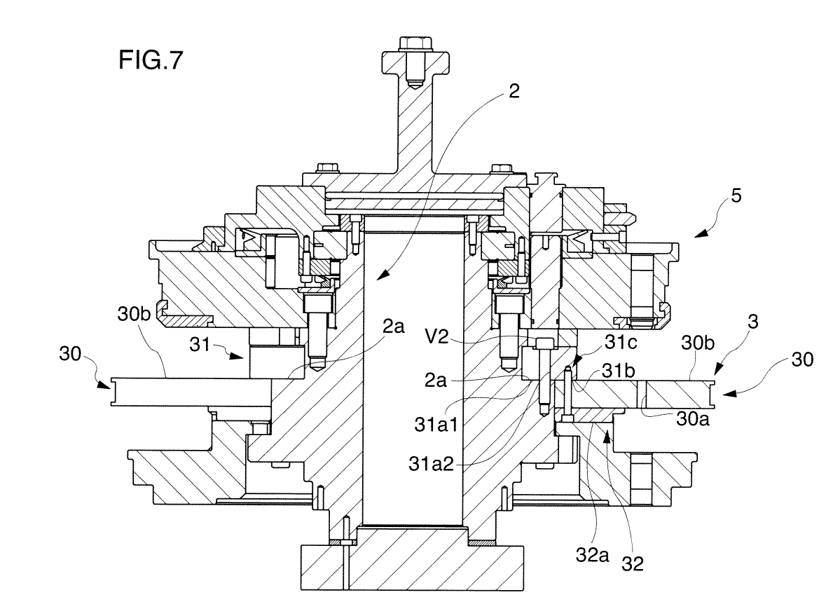

As shown in FIG. 7, a molding machine according to a third embodiment of the present invention is configured such that an upright shaft 2 is provided directly with an upward surface 2a, to which plate units 3 are fixed. Plate attachment members 31 each have mount portions 31a, each of which has a downward surface 31a1 and a fixing portion 31a2. The downward surfaces 31a1 are in intimate contact with the upward surface 2a that is provided directly to the upright shaft 2. The fixing portions 31a2 each fix, from above, corresponding one of the downward surfaces 31a1 to the upward surface 2a. In this configuration in which the upward surface 2a is formed integrally and directly to the upright shaft, irrespective of accuracy in attachment of the respective members, upper surfaces of plates 30 can be relatively positioned with a higher degree of accuracy.

### Fourth Embodiment

Plate units 3 according to the present invention may not necessarily be fixed directly to an upright shaft 2, but may be fixed in a different manner as long as the plate units 3 are accurately operable together with the upright shaft 2.

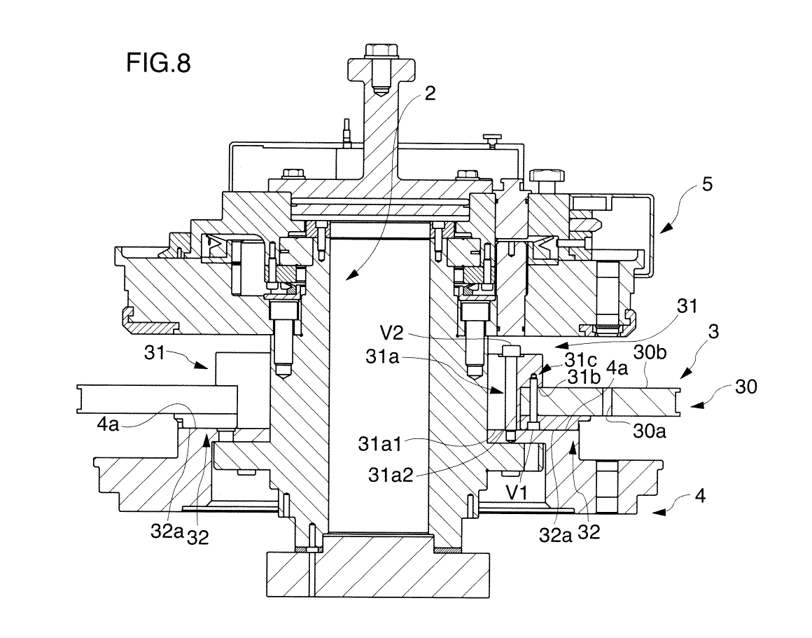

More specifically, as shown in FIG. 8, in a molding machine according to a fourth embodiment of the present invention, the plate units 3 are fixed to an upward surface 4a that is provided not to the upright shaft 2 but to a lower punch retainer 4. Plate attachment members 31 are each configured differently from those of the other embodiments, so as to have an L shape in a sectional view in which downward surfaces 31a1 and a positioning surface 31b are located at different heights.

Even in such a configuration, upper surfaces 30b of plates 30 are each positioned with respect to corresponding one of positioning surfaces 31b. Therefore, the upper surfaces 30b of the plates 30 can be relatively positioned with a high degree of accuracy even in this simple arrangement.

### Fifth Embodiment

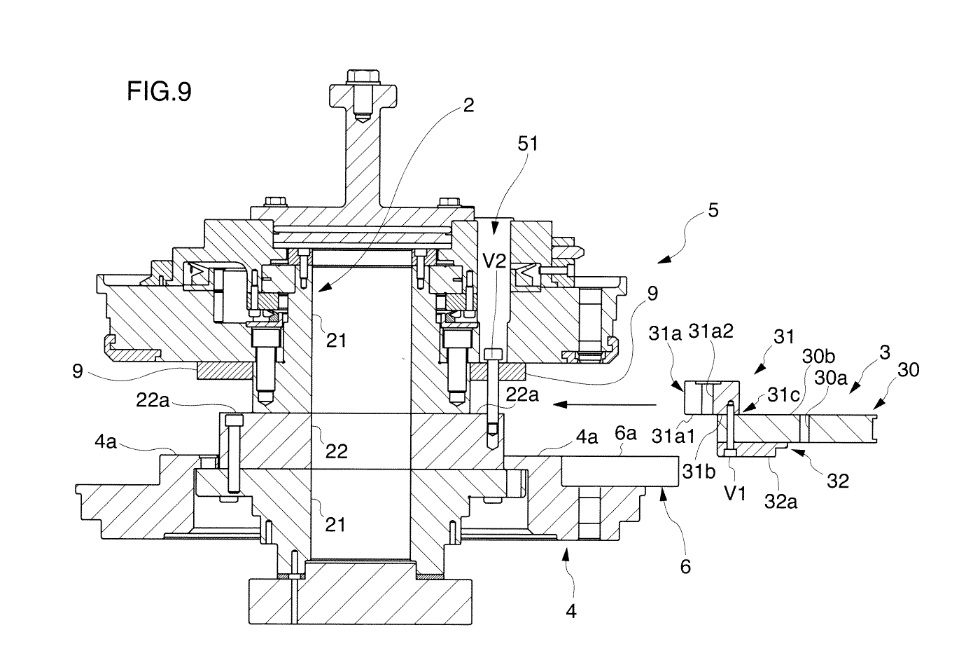

As shown in FIG. 9, a press member 9 having a ring shape is provided above the positions where plate units 3 are attached to a vicinity of an upright shaft 2. After the plate units 3 are attached, the plate units 3 are fixed from above together with the press member 9 by means of bolts V2. Because the single ring press member 9 is provided to expand over the respective plate units 3, upper surfaces 30b of plates 30 can be relatively positioned with a high degree of accuracy.

Specific configurations of other respective portions are not limited to those in the embodiments either and the invention may be modified in various ways within a range not departing from the purposes thereof.

The present invention according to each of the embodiments described above is applied to a rotary compression molding machine. Alternatively, the present invention may be applied to a molding machine including an unrotatable plate. Specific aspects as to the number of divided plates and as to processes of attaching and detaching the plate units are not limited to those of the above embodiments, but may be modified in various ways inclusive of conventional ones.

What is claimed is:

1. A compression molding machine comprising:
a frame;
an upright shaft provided in the frame;
a lower punch retainer attached to the upright shaft and retaining at least one lower punch so as to allow upward and downward reciprocation;
an upper punch retainer attached to the upright shaft and retaining at least one upper punch so as to allow upward and downward reciprocation; and
a plurality of plate units provided between the lower punch retainer and the upper punch retainer; wherein
the plate units each include:
a plate having at least one through bore filled with a powdery material that is compressed by the upper punch and the lower punch; and
a plate attachment member having amount portion mounted to a vicinity of the upright shaft, a positioning surface positioning an upper surface of the plate, and a plate attaching portion attaching the plate from below to above, such that the upper surface of the plate is positioned at the positioning surface.

2. The compression molding machine according to claim 1, wherein the plate units are detachably provided.

3. The compression molding machine according to claim 1, wherein the mount portion has a downward surface in intimate contact with an upward surface provided to a vicinity of the upright shaft, and a fixing portion fixing, from above, the downward surface to the upward surface.

4. The compression molding machine according to claim 3, wherein the upward surface is formed integrally to the upright shaft.

5. The compression molding machine according to claim 3, wherein
the upright shaft includes: a shaft main body to which the lower punch retainer and the upper punch retainer are attached; and a unit attaching portion fixed to the shaft main body, the plate units being attached to the unit attaching portion; and
the upward surface is formed on the unit attaching portion.

6. The compression molding machine according to claim 1, wherein the mount portion has a downward surface in intimate contact with an upward surface provided to a cylindrical member that is externally fitted to the upright shaft, and a fixing portion fixing, from above, the downward surface to the upward surface.

7. The compression molding machine according to claim 1, wherein the mount portion has a downward surface in intimate contact with an upward surface provided to the lower punch retainer, and a fixing portion fixing, from above, the downward surface to the upward surface.

8. The compression molding machine according to claim 1, wherein the plate units have a protective member that covers an inner edge of a lower surface of each of the plates.

9. The compression molding machine according to claim 2, wherein the mount portion has a downward surface in intimate contact with an upward surface provided to a vicinity of the upright shaft, and a fixing portion fixing, from above, the downward surface to the upward surface.

10. The compression molding machine according to claim 9, wherein the upward surface is formed integrally to the upright shaft.

11. The compression molding machine according to claim 9, wherein
the upright shaft includes: a shaft main body to which the lower punch retainer and the upper punch retainer are attached; and a unit attaching portion fixed to the shaft main body, the plate units being attached to the unit attaching portion; and
the upward surface is formed on the unit attaching portion.

12. The compression molding machine according to claim 2, wherein the mount portion has a downward surface in intimate contact with an upward surface provided to a cylindrical member that is externally fitted to the upright shaft, and a fixing portion fixing, from above, the downward surface to the upward surface.

13. The compression molding machine according to claim 2, wherein the mount portion has a downward surface in intimate contact with an upward surface provided to the lower punch retainer, and a fixing portion fixing, from above, the downward surface to the upward surface.

14. The compression molding machine according to claim 2, wherein the plate units have a protective member that covers an inner edge of a lower surface of each of the plates.
